(19) United States
(12) Patent Application Publication
(10) Pub. No.: US 2015/0377336 A1
(43) Pub. Date: Dec. 31, 2015

(54) DRIVE PLATE AND METHOD FOR MANUFACTURING THE SAME

(71) Applicant: AISIN AW CO., LTD., Anjo-shi, Aichi (JP)

(72) Inventors: Naohisa MOMIYAMA, Anjo (JP); Akitomo SUZUKI, Anjo (JP); Ken SHIMIZU, Anjo (JP); Takamitsu KUROYANAGI, Anjo (JP); Kenta ITAYAMA, Anjo (JP); Motoaki KAMIMURA, Toyota (JP); Sachio HONJO, Anjo (JP); Tetsuya OTSUBO, Anjo (JP); Tatsushi OKUDA, Toyoake (JP); Yoshitomo IZAWA, Gamagori (JP); Tsuyoshi AOYAMA, Nagakute (JP); Hiroshi SHIBATA, Takahama (JP); Gen HAMADA, Toyota (JP); Masahiro NAKAMURA, Anjo (JP)

(73) Assignee: AISIN AW CO., LTD., Anjo-shi, Aichi-ken (JP)

(21) Appl. No.: 14/765,470

(22) PCT Filed: Mar. 14, 2014
(86) PCT No.: PCT/JP2014/056947

§ 371 Date: Aug. 3, 2015

(30) Foreign Application Priority Data
Mar. 15, 2013 (JP) 2013-052929
Mar. 13, 2014 (JP) 2014-050246

(51) Int. Cl. F16H 55/06; F16H 55/17; B21K 1/30

(52) U.S. Cl. CPC F16H 55/06; B21K 1/30; F16H 55/17

(57) ABSTRACT

A drive plate includes a plate section coupled to a crankshaft of an engine and a rim section including a plurality of teeth that meshes with a pinon gear of a cell motor for cranking the engine. The plate section and the rim section are integrally molded by press working the drive plate in an axial direction. A free end on a side opposite to a base end which is connected to the plate section of the rim section is brought closer than the base end to a central axis of the plate section, that is, the drive plate.

### CROSS REFERENCE TO RELATED APPLICATIONS

This application is a National Stage of International Application No. PCT/JP2014/056947 filed Mar. 14, 2014, claiming priority based on Japanese Patent Application Nos. 2014-050246 filed Mar. 13, 2014 and 2013-052929 filed Mar. 15, 2013, the contents of all of which are incorporated herein by reference in their entirety.

### TECHNICAL FIELD

The present subject matter relates to a drive plate that transmits power from an engine to a power transmitting subject, and a method for manufacturing the same.

### BACKGROUND ART

Conventionally, for this type of drive plate, a drive plate is known in which a plate section and a ring gear section (rim section) are integrally molded by press working, the plate section being coupled to a crankshaft of an engine and being coupled to a torque converter, which is a power transmitting subject, via a set block, and the ring gear section including a plurality of teeth that meshes with a pinion gear of a motor for cranking the engine (see e.g., Patent Document 1 and Patent Document 2). In such a drive plate, the manufacturing cost can be greatly reduced since a cutting process of the ring gear, a welding process of the plate and the ring gear, and the like are not necessary as opposed to the drive plate that includes a plate and a ring gear formed as separate bodies and coupled with a bolt, and the like.

### RELATED ART DOCUMENT

### Patent Document

[Patent Document 1] Japanese Patent Application Publication No. 10-132052 (JP 10-132052 A)

[Patent Document 2] Japanese Patent Application Publication No. 2007-170596 (JP 2007-170596 A)

### SUMMARY OF THE INVENTION

However, when the drive plate integrally molded by press working, as described above, is used, the sound quality and the sound pressure of gear noise generated when cranking the engine are not preferable to hear compared to the case in which the drive plate including the plate and the ring gear formed as separate bodies is used.

It is a main object to improve the sound quality and the sound pressure of gear noise of the drive plate integrally molded by press working.

The drive plate and the method for manufacturing the same adopt the following means for achieving the main object described above.

A drive plate ¥ includes a disk-shaped plate section coupled to a crankshaft of an engine and an annular rim section formed by bending an outer circumferential end of the plate section, and which transmits power from the engine to a power transmitting subject, including

a plurality of teeth is formed on an outer circumferential surface of the rim section by press working the drive plate in an axial direction, a free end on a side opposite to a base end which is connected to the plate section of the rim section comes closer than the base end to a central axis of the plate section.

Research has been carried out in order to improve the sound quality and the sound pressure of gear noise of the drive plate integrally molded by press working, and found as a result, that the lowering of the gear meshing ratio due to the molding accuracy of the teeth of the rim section by press working is a factor in degradation of the sound quality and the sound pressure of gear noise in the drive plate. In other words, if a plurality of teeth is formed on the rim section of the drive plate by press working the drive plate in the axial direction, a so-called addendum sag in which the height from the bottom land of the tooth surface contributing to the meshing cannot be sufficiently ensured becomes large on the free end side, which is on a side opposite to the base end, compared to the base end side which is connected to the plate section of the rim section. Therefore, when the teeth of the rim section of the drive plate integrally molded by press working mesh with the teeth of the gear of the motor without taking any measures, the meshing ratio on the free end side of the rim section lowers, whereby the sound quality, and the like of gear noise at the time of cranking is degraded. In light of this, in the drive plate, the free end of the rim section is brought closer than the base end to the central axis of the plate section. Thus, the teeth of the rim section well mesh with the teeth of the gear of the motor on the base end side well formed with the tooth surface, and the teeth of the rim section are prevented from meshing with the teeth of the gear of the motor on the free end side where addendum sag is large to suppress the degradation of the sound quality, and the like of gear noise caused by imperfect meshing. As a result, the sound quality and the sound pressure of gear noise of the drive plate integrally molded by press working can be improved.

The plurality of teeth may be formed on the rim section by applying a press load in a direction from the free end toward the base end. Furthermore, the plurality of teeth may be formed on the rim section by press working using a fixed die and a movable die, and the base end of the rim section may be the end on the fixed die side and the free end of the rim section may be the end on the movable die side. The free end of the rim section may be brought closer than the base end to the central axis of the plate section after the molding of the teeth by press working is completed, after the drive plate is extracted from the fixed die, or when the drive plate is extracted from the fixed die.

An intersecting line of a tooth surface of each tooth of the rim section and a cylindrical surface concentric with the plate section may come closer to a bottom land from the free end toward the base end, and the bottom land of each tooth of the rim section may come closer to the central axis of the plate section from the base end toward the free end. Thus, the teeth of the rim section can be more reliably suppressed from meshing with the teeth of the gear of the motor on the free end side where addendum sag is large.

Furthermore, the plate section may include a coupling portion to be coupled to the power transmitting subject, and the plate section and the rim section may be deformed on an outer side of the coupling portion such that the free end of the rim section comes closer than the base end to the central axis of the plate section. Thus, the deformation of the coupling portion with the power transmitting subject of the plate section, and furthermore, the coupling portion with the crankshaft of the plate section can be well suppressed, the plate section and the power transmitting subject can be accurately coupled, and the plate section and the crankshaft can be accurately coupled. The plate section may be coupled to the power transmitting subject via the set block, and the coupling portion may include a contacting surface with the set block of the plate section.

A method for manufacturing a drive plate relates to a method for manufacturing a drive plate which includes a disk-shaped plate section coupled to a crankshaft of an engine and a rim section formed by bending an outer circumferential edge of the plate section, and which transmits power from the engine to a power transmitting subject; the method including the steps of:

forming a plurality of teeth on an outer circumferential surface of the rim section by press working the drive plate in an axial direction, and deforming at least the rim section such that a free end on a side opposite to a base end which is connected to the plate section comes closer than the base end to a central axis of the plate section.

According to an embodiment, the sound quality and the sound pressure of gear noise of the drive plate integrally molded by press working can be improved.

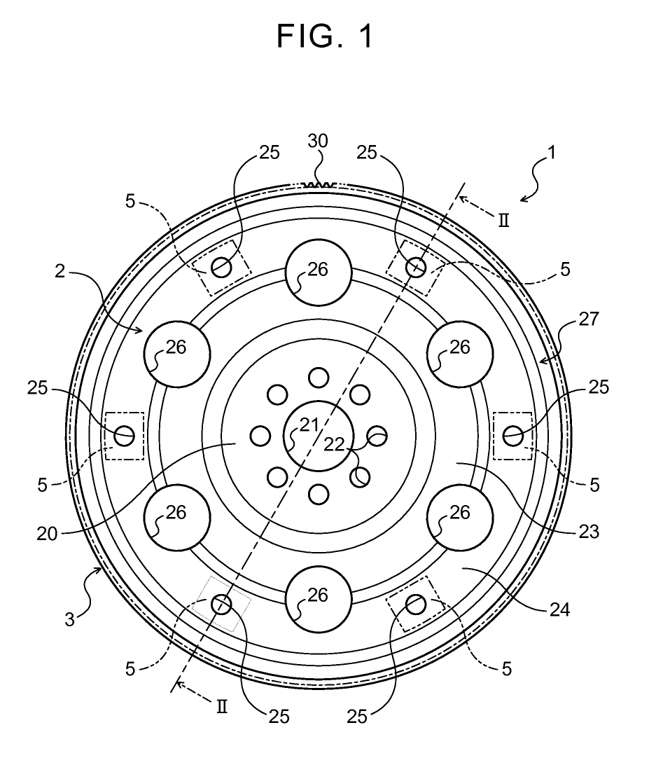

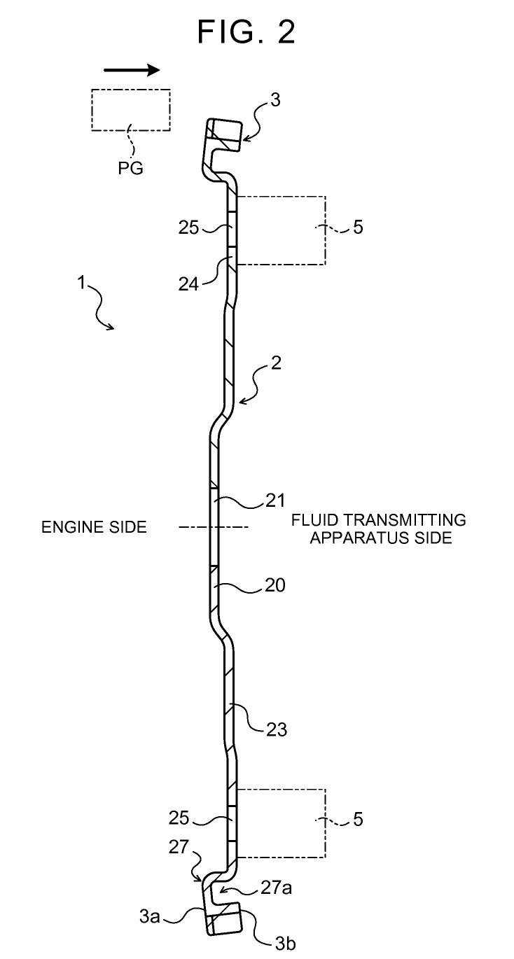

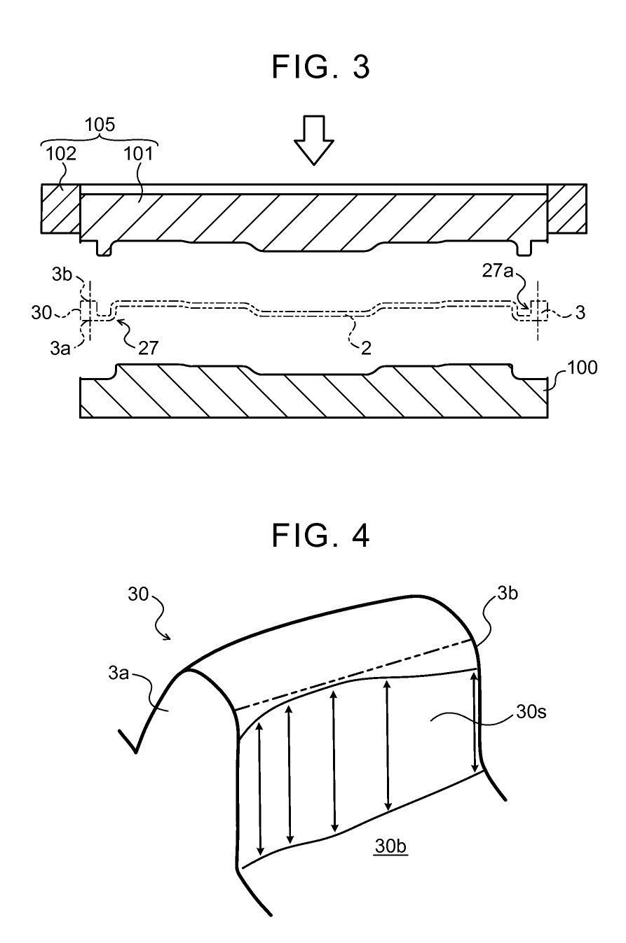

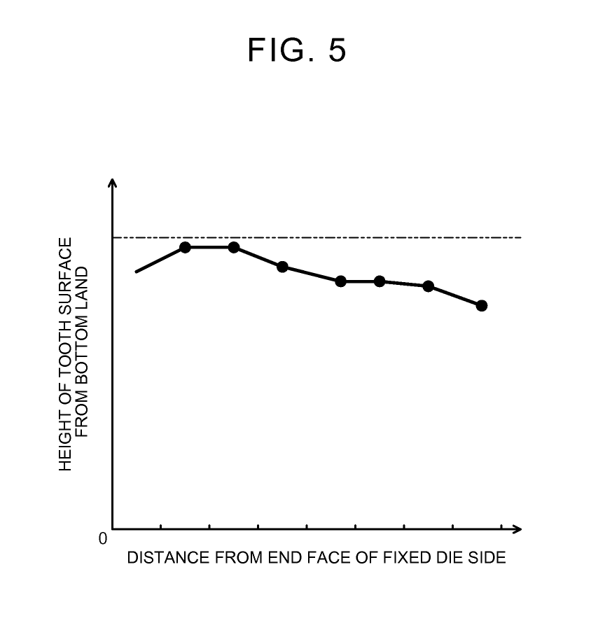

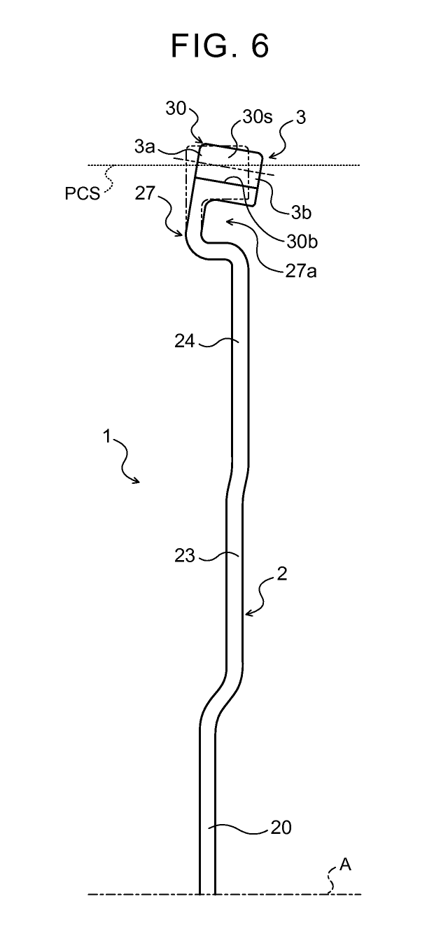

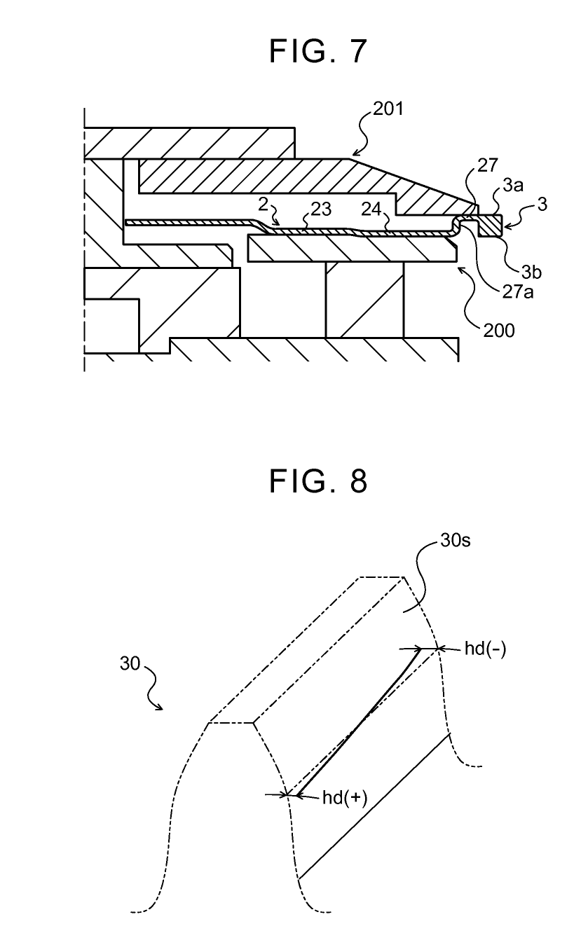

### BRIEF DESCRIPTION OF THE DRAWINGS

[FIG. 1] FIG. 1 a plan view showing a drive plate according to one embodiment.

[FIG. 2] FIG. 2 is a cross-sectional view taken along line II-II of FIG. 1.

[FIG. 3] FIG. 3 is a schematic view showing a manufacturing procedure of the drive plate.

[FIG. 4] FIG. 4 is an enlarged perspective view schematically showing a tooth of a rim section formed by press working.

[FIG. 5] FIG. 5 is a table showing a relationship of a position in a face width direction and a height of a tooth surface from a bottom land in the tooth of the rim section formed by press working.

[FIG. 6] FIG. 6 is an enlarged view of a main portion showing the drive plate according to one embodiment.

[FIG. 7] FIG. 7 is a schematic view showing a manufacturing procedure of the drive plate.

[FIG. 8] FIG. 8 is a schematic view showing a measuring procedure of a tooth trace error.

### DESCRIPTION OF A PREFERRED EMBODIMENT

A preferred embodiment will be described below with reference to the drawings.

FIG. 1 is a plan view showing a drive plate 1 according to one embodiment, and FIG. 2 is a cross-sectional view taken along line II-II of FIG. 1. A drive plate 1 shown in the figures is used to transmit power output from an engine (internal combustion engine) (not shown), serving as a motor mounted on a vehicle, to a fluid transmission apparatus (not shown) such as a torque converter and a fluid coupling, which is a power transmitting subject. As shown in the figure, the drive plate 1 includes a disk-shaped plate section 2 coupled to a crankshaft of the engine and the fluid transmission apparatus, and an annular rim section (ring gear section) 3 including a plurality of teeth (external teeth) 30 that can mesh with teeth of a pinion gear PG (see FIG. 2) of a cell motor (not shown) for cranking the engine. The drive plate 1, that is, the plate section 2 and the rim section 3, are integrally molded by press working a plate material having flexibility such as, for example, a cold rolled steel plate.

As shown in the figure, the plate section 2 of the drive plate 1 includes a first coupling portion 20 having a flat annular shape which is formed at a central part. The first coupling portion 20 is formed with a center hole 21 so as to be located at the center of the first coupling portion 20, and a plurality of (eight in the present embodiment) first coupling holes 22 is disposed at equal intervals around the center hole 21. An annular flat portion 23 is formed around the first coupling portion 20 so as to project toward the fluid transmission apparatus from the first coupling portion 20, and a second coupling portion 24 having a flat annular shape is formed around the flat portion 23 so as to project slightly toward the fluid transmission apparatus from the flat portion 23. The second coupling portion 24 is formed with a plurality of (six in the present embodiment) second coupling holes 25 at equal intervals, and the second coupling portion 24 includes a flat contacting surface located around a second coupling hole 25, which is in contact with a set block to be welded, for example, to a front cover of the fluid transmission apparatus.

The plate section 2 is formed with a plurality of (six in the present embodiment) lightening holes 26 at equal intervals. In the present embodiment, the lightening hole 26 is a circular hole and is disposed between the second coupling holes 25 adjacent to each other so as to span between the flat portion 23 and the second coupling portion 24. Furthermore, the plate section 2 includes an annular narrowing portion 27 formed to surround the second coupling portion 24. In the present embodiment, the narrowing portion 27 is formed such that an annular recess 27a is located on the fluid transmission apparatus side.

The crankshaft of the engine and the first coupling portion 20 of the plate section 2 are fastened with a bolt inserted to each first coupling hole 22 such that the recess 27a of the narrowing portion 27 is located on the fluid transmission apparatus side. A set block 5 fixed to the fluid transmission apparatus is brought into contact with the contacting surface on the recess 27a side of the second coupling portion 24 and is fastened to the plate section 2 with a bolt inserted to each second coupling hole 25. The engine and the fluid transmission apparatus are thus coupled via the drive plate 1, and the power output from the engine can be transmitted to the fluid transmission apparatus, which is the power transmitting subject.

The rim section 3 includes a base end 3a that is formed by bending an outer circumferential edge of the plate section 2 by press working the drive plate 1 in an axial direction and that is connected to the plate section 2, and a free end 3b that is located on the opposite side of the base end 3a. As shown in FIG. 2, in the present embodiment, the rim section 3 is formed around the narrowing portion 27 (recess 27a) of the plate section 2, and the base end 3a of the rim section 3, in conjunction with the entire rim section 3, are connected to the narrowing portion 27 formed in the plate section 2 so as to define the annular recess 27a. The plurality of teeth (external teeth) 30 formed on the outer circumferential surface of the rim section 3 each includes, for example, a tooth surface 30s configured by an involute curve and a flat tip surface, and can mesh with the teeth of the pinion gear PG of the cell motor. Each tooth of the pinion gear PG has a tooth trace extending parallel to an axis center, and the pinion gear PG is coupled to a rotor of the cell motor (not shown) and moved toward the drive plate 1 (fluid transmission apparatus side) from the engine side, as shown in FIG. 2, at the start of the engine. Each tooth of the pinion gear PG then enters between the adjacent teeth 30 from one end in a face width direction of the rim section 3, that is, the base end 3a on the engine side, and the distal end of the pinion gear PG projects toward the fluid transmission apparatus from the other end of the rim section 3, that is, the free end 3b on the fluid transmission apparatus side.

The drive plate 1 described above is formed by mounting a plate material such as a cold rolled steel plate on a fixed die (die) 100 illustrated in FIG. 3 and applying a press load on the plate material, as shown with an outlined arrow in the figure, while a movable die (punch) 105 including a first punch 101 and a tooth profile molding second punch 102 is moved, for example, with respect to the fixed die 100. In the present embodiment, the fixed die 100 and the movable die 105 are configured to integrally mold a spur gear shaped rim section 3, which includes the tooth trace extending parallel to the axis center, with the plate section 2. Furthermore, in the present embodiment, as shown in FIG. 3, the recess 27a of the narrowing portion 27 is formed on the movable die 105 (first punch 101) side with the cooperative movement of the fixed die 100 and the movable die 105. The end of the rim section 3 located on the fixed die 100 side after the molding of the rim section 3, and the like by press working (after completion of application of press load) (end on the fixed die 100 side) becomes the base end 3a that is connected to the narrowing portion 27 of the plate section 2. The end of the rim section 3 located on the movable die 105 side after the molding of the rim section 3, and the like by press working (end on the movable die 105 side) becomes the free end 3b. The plurality of teeth 30 are formed on the rim section 3 by applying the press load in the direction from the free end 3b toward the base end 3a (see outlined arrow in FIG. 3).

After integrally molding the plate section 2 and the rim section 3 of the drive plate 1 by press working using the fixed die 100 and the movable die 105 as described above, a so-called addendum sag in which the height from a bottom land 30b (root surface, i.e., intersecting line of tooth surface 30s and root cylinder) of the tooth surface 30s contributing to the meshing cannot be sufficiently ensured becomes large on the free end 3b side (end face of the end on the movable die 105 side) compared to the base end 3a side (end face of the end on the fixed die 100 side) in each tooth 30 of the rim section 3, as shown in FIGS. 4 and 5. In other words, when the press load in the direction from the free end 3b toward the base end 3a is applied on the plate material, the material is filled into a gap of the fixed die 100 and the movable die 105 from the base end 3a side, whereby the material to be filled in the gap lacks on the free end 3b side and the addendum sag becomes large on the free end 3b side compared to the base end 3a side.

A chain double-dashed line in FIG. 4 indicates the intersecting line of the tip surface and the tooth surface 30s when the tooth 30 is formed ideally (as designed), and a chain double-dashed line in FIG. 5 indicates the height of the tooth surface 30s from the bottom land 30b when the tooth 30 is formed ideally (as designed).

As a result of research, it became apparent that the lowering of the meshing ratio of the rim section (ring gear section) 3 and the pinion gear PG due to the molding accuracy of the tooth 30 by press working as described above becomes a factor in degradation of the sound quality and the sound pressure of gear noise in the drive plate 1. Therefore, the press load at the time of press working can be further increased to suppress the occurrence of addendum sag described above as a measure for improving the sound quality and the sound pressure of gear noise of the drive plate 1 integrally molded by press working. If the press load at the time of press working is increased, the occurrence of the addendum sag can be suppressed but the lifespan of the fixed die 100 and the movable die 105 becomes short and the manufacturing cost increases. The advantages of integrally molding the plate section 2 and the rim section 3 are thus lost.

In light of this, the plate section 2 and the rim section 3 are deformed such that the free end 3b (end on the movable die 105 side) of the rim section 3 comes minutely closer than the base end 3a (end on the fixed die 100 side) to a central axis A of the plate section 2, that is, the drive plate 1(shifted by extremely small amount), as shown in FIG. 6. In other words, the plate section 2 and the rim section 3 are deformed such that the tooth trace, which is the intersecting line of a pitch cylindrical surface PCS of the tooth 30 and the tooth surface 30s, when the plate section 2 and the rim section 3 are not deformed as described above, comes minutely closer to the central axis A of the plate section 2, that is, the drive plate 1 from the base end 3a toward the free end 3b, as shown with a chain double-dashed line in FIG. 6.

Specifically, for example, a load is applied on the plate section 2 and the rim section 3 using a jig 200 and a pressurizing device 201 as shown in FIG. 7 after the press working is completed (after the drive plate 1 is extracted from the fixed die 100), and the plate section 2 and the rim section 3 are plastic-deformed such that the free end 3b comes minutely closer than the base end 3a to the central axis A at the outer side of the outer circumference of the contacting surface with the second coupling portion 24 of the plate section 2, that is, the set block 5 of the second coupling portion 24. In the example of FIG. 7, the jig 200 supports the flat portion 23 and the second coupling portion 24 of the plate section 2 from the base end 3a side of the rim section 3, and the pressurizing device 201 applies a predefined load on the narrowing portion 27 (rear surface) from the free end 3b side of the rim section 3. The load from the pressurizing device 201 for deforming the plate section 2 and the rim section 3 as described above is determined (adapted) in advance through experiments, analysis, and the like.

The plate section 2 and the rim section 3 are deformed such that the free end 3b comes minutely closer than the base end 3a to the central axis A of the plate section 2, that is, the drive plate 1, whereby the intersecting line of the tooth surface 30s of each tooth 30 of the rim section 3 and the pitch cylindrical surface PCS concentric with the plate section 2, that is, the drive plate 1 comes closer to the bottom land 30b from the free end 3b toward the base end 3a (see dashed line in FIG. 6). The bottom land 30b of each tooth 30 of the rim section 3 comes closer to the central axis A of the plate section 2, that is, the drive plate 1 from the base end 3a toward the free end 3b, and the diameter of the root circle at the end face of the free end 3b becomes minutely smaller than the diameter of the root circle at the end face of the base end 3a.

In the drive plate 1, the tooth 30 of the rim section 3 well meshes with the tooth of the pinion gear PG on the base end 3a side (mainly base end 3a side from the middle in the face width direction) well formed with the tooth surface 30s. The tooth 30 of the rim section 3 is more reliably suppressed from meshing with the tooth of the pinion gear PG on the free end 3b side where addendum sag is large, whereby the degradation of the sound quality, and the like of gear noise caused by the imperfect meshing can be suppressed. The deformation of the second coupling portion 24 of the plate section 2, and furthermore, the first coupling portion 20 of the plate section 2 coupled to the crankshaft is well suppressed, and the plate section 2, that is, the drive plate 1 and the crankshaft of the engine and the fluid transmission apparatus, which are the power transmitting subjects, can be more accurately coupled by deforming the plate section 2 and the rim section 3 on the outer side of the second coupling portion 24 of the plate section 2 which is coupled to the fluid transmission apparatus via the set block 5.

In the drive plate 1 of the present embodiment configured as described above, whether or not the plate section 2 and the rim section 3 are appropriately deformed in order to improve the sound quality, and the like of gear noise is managed using a tooth trace error hd shown in FIG. 8, that is, a deviation amount from the design tooth trace (ideal tooth trace, see chain double-dashed line in FIG. 8) of the actual tooth trace (see continuous line in FIG. 8) which is measured in the tangent direction of a base circle at a right angle to the axis. In the present embodiment, the intersecting line of the pitch cylindrical surface PCS of the tooth 30 when the plate section 2 and the rim section 3 are not deformed as described above and the design tooth surface of the tooth 30 when the plate section 2 and the rim section 3 are deformed as described above is a design tooth trace, and the intersecting line of the pitch cylindrical surface PCS of the tooth 30 when the plate section 2 and the rim section 3 are not deformed as described above and the tooth surface 30s after the plate section 2 and the rim section 3 are deformed as described above is an actual tooth trace. If a tooth trace error amount Δhd in which the maximum value is subtracted from the minimum value of a plurality of tooth trace errors hd which is measured in the predetermined tooth trace examination range for the tooth 30 of the rim section 3 is within a range from the predetermined upper limit value to lower limit value, the plate section 2 and the rim section 3 are considered to be appropriately deformed and the sound quality and the sound pressure of gear noise of the drive plate 1 are considered to be improved. In the present embodiment, the upper limit value of the tooth trace error amount Δhd is, for example, a negative value determined based on the minimum value of the tooth trace error amount Δhd of the pinion gear PG, which is the meshing subject of the rim section 3, and the lower limit value is a negative value determined in view of the durability of each tooth 30. As shown in FIG. 8, the tooth trace error hd is a positive value if the tooth surface 30s is bulged out compared to a design surface (ideal surface), and the tooth trace error hd is a negative value if the tooth surface 30s is recessed (thinned) compared to the design surface (ideal surface).

As described above, in the drive plate 1 in which the plate section 2 and the rim section 3 are integrally formed by press working, the tooth 30 of the rim section 3 well meshes with the pinion gear PG on the base end 3a side (end on the fixed die 100 side) well formed with the tooth surface 30s, and the tooth 30 of the rim section 3 does not mesh with the tooth of the pinion gear PG on the free end 3b side (end on the movable die 105 side) where addendum sag is large, whereby the degradation of the sound quality, and the like of gear noise caused by the imperfect meshing can be suppressed. Therefore, the sound quality and the sound pressure of gear noise can be improved in the drive plate 1.

When manufacturing the drive plate 1, the press load does not need to be increased as described above, and thus the lifespan of the fixed die 100 and the movable die 105 can be extended and the manufacturing cost can be reduced. Furthermore, the fixed die 100 and the movable die 105 do not need to be reconfigured when manufacturing the drive plate 1, and furthermore, the process of deforming the plate section 2 and the rim section 3 can be carried out simultaneously, for example, with the other processes in the subsequent step after the pressing work is completed, whereby the substantive increase in the number of steps can be suppressed.

The plate section 2 and the rim section 3 may be deformed such that the free end 3b (end on the movable die 105 side) comes closer than the base end 3a (end on the fixed die 100 side) to the central axis A of the plate section 2 (drive plate 1) after the molding of the rim section 3, the tooth 30, and the like by press working is completed (after completion of application of press load). Therefore, the plate section 2 and the rim section 3 may be deformed when the drive plate 1 is extracted from the fixed die 100. Furthermore, the drive plate 1 may be deformed such that the free end 3b of the rim section 3 comes closer than the base end 3a to the central axis A of the plate section 2 when the first punch 101 is separated from the fixed die 100 by utilizing that the rim section 3 is pulled by the first punch 101 with the annular projection for forming the recess 27a. Only the rim section 3 may be deformed and the plate section 2 may not be deformed such that the free end 3b comes closer than the base end 3a to the central axis A of the plate section 2 (drive plate 1). Furthermore, when an extended portion extended from the plate section 2 toward the fluid transmission apparatus is fixed (welded) to a structural element of the fluid transmission apparatus to couple the drive plate 1 and the fluid transmission apparatus without using the set block 5, at least the rim section 3 may be deformed on the outer side of the extended portion. Furthermore, the recess 27a of the narrowing portion 27 is located on the movable die 105 side in the drive plate 1 described above, but the drive plate 1 may be configured such that the recess 27a of the narrowing portion 27 is located on the fixed die 100 side. Moreover, when starting the engine, the pinion gear PG may be moved from the fluid transmission apparatus side toward the drive plate 1.

An embodiment has been described above, but the subject matter herein is not limited to such an embodiment, and various changes may be made as one skilled in the art would understand.

### INDUSTRIAL APPLICABILITY

The subject matter described herein can be used in a manufacturing industry of a drive plate that transmits power from the engine to the power transmitting subject.

1.-9. (canceled)

10. A drive plate which includes a disk-shaped plate section coupled to a crankshaft of an engine and an annular rim section formed by bending an outer circumferential end of the plate section, and which transmits power from the engine to a power transmitting subject, comprising:
a plurality of teeth is formed on an outer circumferential surface of the rim section by press working the drive plate in an axial direction, a free end on a side opposite to a base end which is connected to the plate section of the rim section comes closer than the base end to a central axis of the plate section.

11. The drive plate according to claim 10, wherein
the plurality of teeth is formed on the rim section by applying a press load in a direction from the free end toward the base end.

12. The drive plate according to claim 10, wherein
the plurality of teeth is formed on the rim section by press working using a fixed die and a movable die; and
the base end of the rim section is an end on the fixed die side, and the free end of the rim section is an end on the movable die side.

13. The drive plate according to claim 11, wherein
the plurality of teeth is formed on the rim section by press working using a fixed die and a movable die; and
the base end of the rim section is an end on the fixed die side, and the free end of the rim section is an end on the movable die side.

14. The drive plate according to claim 10, wherein
an intersecting line of a tooth surface of each tooth of the rim section and a cylindrical surface concentric with the plate section comes closer to a bottom land from the free end toward the base end.

15. The drive plate according to claim 13, wherein
an intersecting line of a tooth surface of each tooth of the rim section and a cylindrical surface concentric with the plate section comes closer to a bottom land from the free end toward the base end.

16. The drive plate according to claim 10, wherein
a bottom land of each tooth of the rim section comes closer to the central axis of the plate section from the base end toward the free end.

17. The drive plate according to claim 15, wherein
a bottom land of each tooth of the rim section comes closer to the central axis of the plate section from the base end toward the free end.

18. The drive plate according to claim 10, wherein
the plate section includes a coupling portion to be coupled to the power transmitting subject; and
the plate section and the rim section are deformed on an outer side of the coupling portion such that the free end of the rim section comes closer than the base end to the central axis of the plate section.

19. The drive plate according to claim 17, wherein
the plate section includes a coupling portion to be coupled to the power transmitting subject; and
the plate section and the rim section are deformed on an outer side of the coupling portion such that the free end of the rim section comes closer than the base end to the central axis of the plate section.

20. The drive plate according to claim 19, wherein
the plate section is coupled to the power transmitting subject via a set block; and
the coupling portion includes a contacting surface with the set block of the plate section.

21. The drive plate according to claim 10, wherein
the base end of the rim section, in conjunction with the rim section, is connected to a narrowing portion formed in the plate section so as to define an annular recess.

22. The drive plate according to claim 20, wherein
the base end of the rim section, in conjunction with the rim section, is connected to a narrowing portion formed in the plate section so as to define an annular recess.

23. A method for manufacturing a drive plate which includes a disk-shaped plate section coupled to a crankshaft of an engine and a rim section formed by bending an outer circumferential edge of the plate section, and which transmits power from the engine to a power transmitting subject; the method characterized by comprising:
forming a plurality of teeth on an outer circumferential surface of the rim section by press working the drive plate in an axial direction, and deforming at least the rim section such that a free end on a side opposite to a base end which is connected to the plate section comes closer than the base end to a central axis of the plate section.
